(19) United States
(12) Patent Application Publication
(10) Pub. No.: US 2006/0098165 A1
(43) Pub. Date: May 11, 2006

(54) Method and apparatus for disrupting digital photography

(76) Inventor: Manuel Lynch, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/256,391

(22) Filed: Oct. 19, 2005

Related U.S. Application Data
(60) Provisional application No. 60/620,305, filed on Oct. 19, 2004.
(60) Provisional application No. 60/681,072, filed on May 13, 2005.

(51) Int. Cl. G03B 21/32

(52) U.S. Cl. 352/85

(57) ABSTRACT

A method and apparatus for disrupting digital photography uses one or more infrared, LED-based light sources that emit light generally not visible to the human eye yet readily detected by digital imaging equipment. Such detected infrared light disrupts the quality of an image that is obtained from a semi-conductor-based light detector and digitally recorded. Thus, digitally-recorded images are disrupted without disrupting live viewing of such images.

### CROSS-REFERENCE TO RELATED APPLICATIONS

This application claims priority to U.S. Provisional Patent Application Nos. 60/620,305, filed Oct. 19, 2004 and 60/681,072, filed May 13, 2005. The entirety of each priority application is hereby incorporated by reference.

### BACKGROUND OF THE INVENTION

1. Field of the Invention

The present invention is in the field of disrupting digital photography. More specifically, the present invention employs light generally outside the visible spectrum to disrupt images digitally-recorded by semiconductor light detector-based photography equipment.

2. Description of the Related Art

Digital imaging, which includes at least digital still photography and videography, is becoming increasingly popular. Technology has enabled development of compact digital cameras and camcorders that are able to record high quality images. Such cameras can have high memory capabilities so as to store many images and/or have long video recording times.

Unfortunately, ever more sophisticated digital imaging technology provides media pirates more options and more versatility in pirating copyrighted materials. For example, movie pirates may use tiny camcorders in purses and/or digital recorders that are about the size of a fountain pen to record an unauthorized copy of a movie as it is shown in a cinema theater. The movie is then illegally distributed without paying a royalty to the movie studio. Further, pirates may record a film before its planned broad release so that pirated versions of the movie may become available before its full domestic release.

Various counter measures are being pursued to combat movie pirating. For example, in order to catch pirates, theater employees sometimes use night vision goggles to survey the audience while a movie is playing. Also, metal detectors can be used in an attempt to keep pirates out of advance screening rooms. However, these methods are labor-intensive, and meet with only limited success. Another group is developing technology to add digital watermarks to movies in order to disrupt digital videography. However, such digital watermarks can only be used in conjunction with digital projection equipment. Many theaters still use traditional, film-reel-based projection equipment.

### SUMMARY OF THE INVENTION

Accordingly, there is a need in the art for a method and apparatus for combating copyright piracy. More specifically, there is need in the art for combating pirates that use digital imaging equipment.

In accordance with one embodiment of the invention, a theater is provided. The theater comprises a stage area, a viewing area comprising a plurality of seats arranged generally facing toward the stage area, and a digital photography disruption system. The digital photography disruption system comprises an infrared light source adapted to direct infrared light generally outwardly from the stage area and at sufficient intensity to be detected by a semiconductor-based light sensor in the viewing area.

In accordance with a further embodiment, the infrared light source comprises a light emitting diode (LED). In a still further embodiment, the stage area comprises a cinema screen, and the infrared LED is disposed behind the screen. In further embodiments, the LED is adapted to pulse according to a pulsing sequence.

In accordance with yet another embodiment of the invention, a screen viewing facility is provided, comprising a stage area comprising a screen, a viewing area generally adjacent the seating area and accommodating viewing of the screen, and a digital photography disruption system. The digital photography disruption system comprises an infrared light source adapted to direct infrared light onto the screen at sufficient intensity to be detected by a semiconductor-based light sensor that is in the viewing area and is directed toward the screen.

In a further embodiment, infrared light is directed onto at least a portion of the screen at an intensity greater than an intensity of visible light projected onto the screen. In another embodiment, the infrared light source comprises an infrared laser. In another embodiment, first and second infrared light sources are spaced apart from one another, and the first and second sources simultaneously direct light at a target portion of the screen.

In accordance with a still further embodiment, a method of disrupting digital photography of a subject comprises providing a source of electromagnetic radiation substantially outside of the visible electromagnetic spectrum, positioning the radiation source on or adjacent the subject, and directing the invisible electromagnetic radiation from the source toward a viewer of the subject. The electromagnetic radiation is provided at an intensity sufficient to be detected by a semiconductor light sensor, but is substantially invisible to a viewer of the subject.

### BRIEF DESCRIPTION OF THE DRAWINGS

FIG. 1 is a top plan view showing an example cinema theater employing aspects in accordance with some embodiments.

FIG. 2 is a view of a front wall of the theater of FIG. 1, illustrating the screen and front wall.

FIG. 3 is a cross-sectional view of the theater of FIG. 1 taken along lines 3-3.

FIG. 4 is a perspective view of an embodiment of a light fixture for use in accordance with certain embodiments of the present invention.

FIG. 5 is an exploded view of the example light fixture of FIG. 4.

FIG. 6 is a schematic diagram of a control system in accordance with one embodiment.

### DETAILED DESCRIPTION OF THE PREFERRED EMBODIMENT

Digital imaging equipment is used to generate a digitally-recorded image. Digitally-recorded photographic images can be easily shared electronically and copied with substantially no degradation of the image. As such, digitally-recorded photographic images can easily and quickly be shared and distributed to many users. For example, digitally-recorded images can be uploaded to the Internet, from which they can be downloaded to thousands of users in a relatively short time.

Throughout this specification, the terms digital photography and digital imaging are broad terms that include creation and recordation of digitally-recorded images. Further, still photography and videography are included within the term photography.

Most digital imaging equipment, such as digital cameras, camcorders and the like, include a semiconductor-based light sensor detector, such as a charge coupled device (CCD) or complementary metal oxide semiconductor (CMOS) chip, that detects electromagnetic radiation, or light. The detected light typically is digitally recorded in the memory of the equipment. Such digitally recorded images are especially conducive to being downloaded and/or viewed on a graphical user interface of a computing device, which may be included in the camera.

Semiconductor light detectors are highly sensitive to infrared light. Although such infrared light is generally not visible to the human eye, it is detected by a silicon detector and recorded as part of the digitally-recorded image. When the digitally-recorded image is later displayed on a graphical interface such as a computer screen, the infrared light is presented as a white or clear portion of the image. More specifically, when a digital camera takes a photograph, and the subject matter includes an infrared light source, the resultant image, when displayed, will show a white glow representing the infrared light source. This glow tends to “wash out” the rest of the image, thus resulting in a disrupted digitally-recorded image. Also, some digital cameras include lens treatments designed to improve light pick-up and improve low light and night performance of the camera. Such treatments can make the camera even more sensitive to infrared light, and thus the “wash out” effect of an infrared source on the rest of the image is even more prevalent.

Since infrared light can have a dramatic effect on a digitally-recorded image, while having substantially no visible effect on live viewing by humans, Applicant has developed several embodiments of methods and apparatus for disrupting digital photography using infrared light. In embodiments discussed below, use of such technology is discussed in the context of combating movie piracy. However, several other applications are contemplated, such as protecting stage theater, art exhibitions, broadcasts, presentations and the like.

Throughout this specification, the term “infrared light” encompasses light having a wavelength greater than light that is visible to the human eye. Generally speaking, infrared light includes at least any light having a wavelength greater than about 840 mn. Additionally, for purposes of this specification, infrared light may also include light in the “deep red” portion of the electromagnetic spectrum. Such light may technically fall within the visible spectrum, but is very difficult, if not practically impossible, for the human eye to detect.

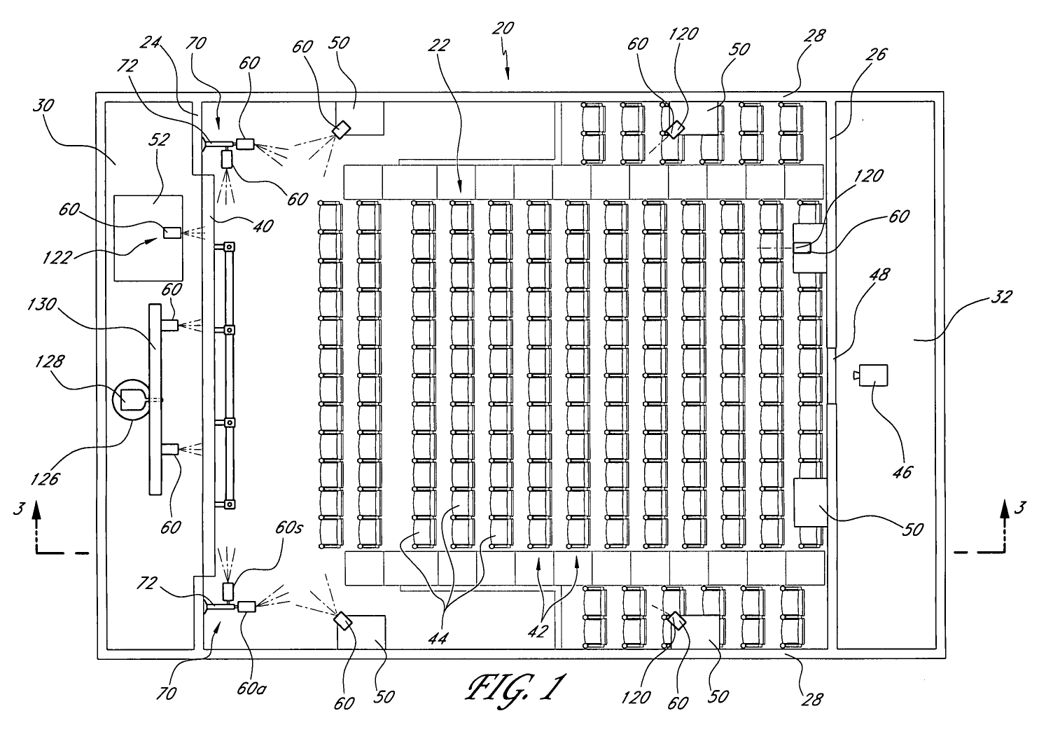

With reference to FIGS. 1-3, an example cinema theater 20 is presented. The illustrated theater 20 comprises a viewing area 22 having front 24, back 26 and side 28 walls, a stage area 30 separated from the viewing area 22 by the front wall 24, and a projector room 32 separated from the viewing area 22 by the back wall 26. The front wall 24 includes a screen 40. The viewing area 22 includes several rows 42 of seats 44 that are generally arranged so that a viewer seated in each seat 44 is directed generally toward the screen 40. A projector 46 preferably is arranged in the projection room 32, and is adapted to project an image through a projection room window 48 and onto the screen 40.

In order to enhance the theater experience, many movie theaters include sophisticated sound systems. For example, such sound systems may include a plurality of speakers 50 mounted to front 24, side 28 and back 26 walls of the viewing area 22. Additionally, large speakers 52 are often arranged on the stage 30 behind the screen 40 so as to be hidden from view of the patrons in the seats 44.

In accordance with one embodiment, one or a plurality of infrared light sources 60 are disposed in the theater 20 and are adapted to direct infrared light onto at least a portion of the screen 40 with an intensity greater than an intensity of the visible light projected onto the screen by the projector 46. Since each infrared source 60 directs only infrared light at the screen 40, patrons viewing the movie live will not detect the infrared light. However, a digitally-recorded image taken of the screen 40 will record the infrared light, and the digitally-recorded image will include white or blank portions of the screen that are displayed when the images are “played back”. As such, the digitally-recorded image is disrupted. In accordance with another embodiment, infrared light is applied to at least portions of the screen 40 with an intensity that fades but does not completely wash out the digitally-recorded image. However, the image is degraded and, preferably, inconsistent and of very poor quality.

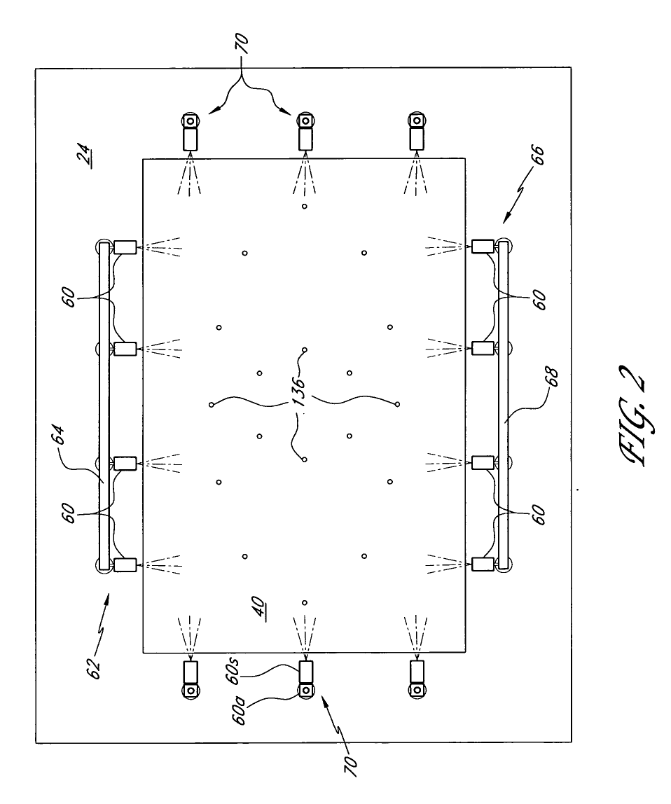

With continued reference to FIGS. 1-3, several infrared light sources 60 are illustrated arranged at different locations in the theater 20. For example, in accordance with one embodiment, infrared light sources 60 are arranged immediately adjacent the screen 40. As best shown in FIG. 2, an upper group 62 of a plurality of infrared light sources 60 are disposed generally above the screen 40. The upper group 62 includes a mount 64 upon which a plurality of light sources 60 are mounted, and the sources 60 are adapted to direct infrared light generally toward the screen 40 so as to wash at least part of the screen with infrared light. Similarly, a lower group 66 of a plurality of infrared light sources 60 are arranged on a lower mount 68 and adapted to direct infrared light onto the screen 40.

With continued specific reference to FIG. 2, a plurality of side-mounted light sources 70 are also provided. In the illustrated embodiment, each side-mounted infrared light source 72 includes a mount member 72 upon which an infrared source 60s is mounted and adapted to direct infrared light onto the screen 40. The infrared sources 60s can be directed to different parts of the screen 40 or, in another embodiment, can be adapted to work in concert to selectively concentrate multiple infrared sources on a single portion of the screen. Such concerted lighting greatly improves the intensity of light directed onto that area, and creates an infrared “hot spot.”

In still another embodiment, one or more of the infrared light sources 60 are disposed on a motorized mount member that is adapted to change the direction of the corresponding light source so that the washed-out portion of the screen can be selectively moved about in order to even further disrupt a digitally-recorded image, especially a video image.

In the illustrated embodiment, multiple infrared light sources 60 are disposed above, below and to the sides of the screen. However, it is to be understood that, in additional embodiments, more or less infrared sources may be employed. For example, only a single infrared light source may be used and may be mounted on any one of the upper, lower or side areas of the screen. Combinations of one, two, three or more of such infrared light sources working independently or in concert are also contemplated. Also, due to the close proximity of the light sources to the screen, less light intensity is required to disrupt the digitally-recordable image than would be needed were the light sources spaced significantly from the screen.

In accordance with one embodiment, the infrared light sources 60 comprise light emitting diodes (LEDs). LEDs typically are limited spectrum light sources, and most preferably the LEDs emit light at have a rated wavelength greater than about 840 nm so as not to be visible to the human eye. Variation is anticipated, and Applicant also contemplates use of LED emitters that emit light that may technically be within the visible spectrum (i.e., deep red wavelengths), but are very difficult for humans to detect. In a particularly preferred embodiment, the infrared emitter is a broadband 850 nm infrared emitter available from Osram Opto Semiconductors, disposed in Osram's “Dragon” package, and employing thin-film technology. It is to be understood that other infrared-emitting LEDs can also be used in other embodiments. Preferably, such emitters do not emit light in the visible spectrum. However, it is to be understood that some light may be generated in the deep red portion of the visible spectrum. Such deep red light may be acceptable so long as it does not interfere significantly with a visible image projected on the screen.

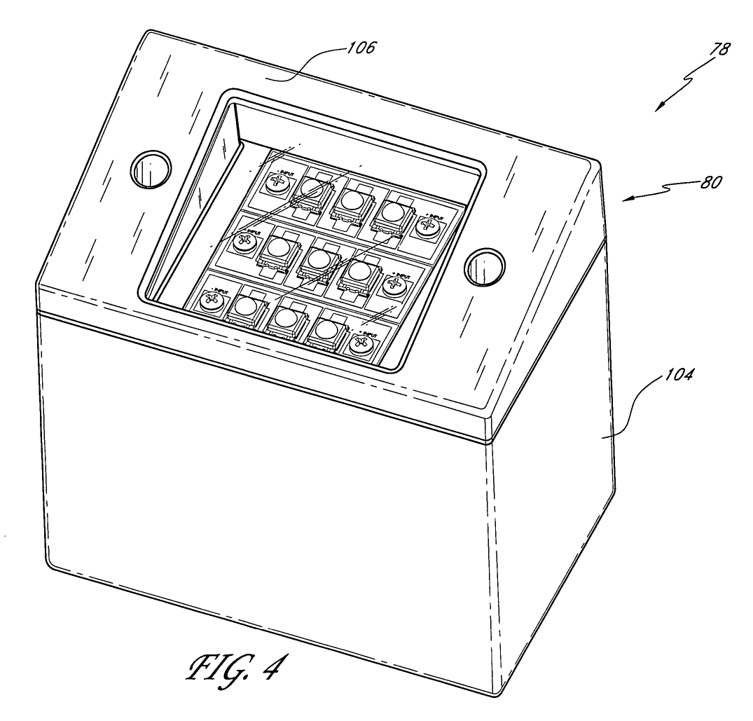

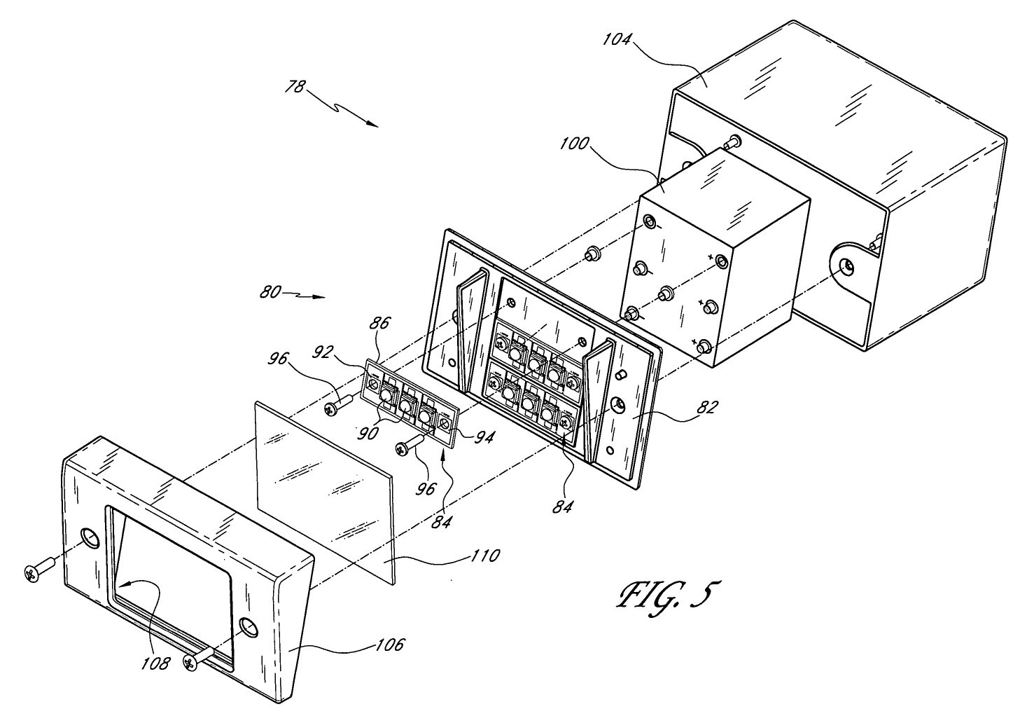

Infrared light-emitting LEDs can generate substantial heat during operation. If the heat of the diode portion of the LED is excessive, the diode may degrade prematurely, thus decreasing the amount of light emitted and limiting the useful life of the infrared light source. With reference next to FIGS. 4 and 5, an embodiment of an LED-based infrared light source 78 is presented. In the illustrated embodiment, the infrared source comprises an LED-based infrared lighting fixture 80 that has advantageous heat sinking properties. Heat is drawn away from the diode and into the heat sink so that the temperature of the diode is controlled.

In the embodiment illustrated in FIGS. 4 and 5, the LED fixture 80 comprises a heat dissipating plate 82 upon which a plurality of LED modules 84 are mounted. Each LED module 84 preferably comprises a heat conductive substrate 86 upon which an electrical circuit is provided. One or a plurality of LEDs 90 are arranged on the circuit, which preferably is adapted so that the LEDs 90 are arranged electrically in series. A negative contact 92 and a positive contact 94 are provided on either end of the series array, and electricity is communicated to the LED module 84 through fasteners 96 that connect to the contacts 92, 94 and to a power driver 100. Each LED module 84 preferably is connected to the heat dissipating plate 82 via the threaded fasteners 96, which engage the power conditioner 100 disposed on the opposite side of the heat dissipating plate 82, and hold the LED module 84 onto the plate 82 so that the heat conductive substrate 86 substantially engages the plate 82.

In the illustrated embodiment, three LED modules 84 are disposed on the heat dissipating plate 82 and connected to the power driver 100. Preferably, the driver is adapted to accept line voltage, such as 120 or 240 VAC, to condition the voltage to a desired DC voltage, such as about 30 VDC, and to deliver it as appropriate across the LED modules 84. In the illustrated embodiment, the modules 84 are arranged electrically in series relative to one another in accordance with a circuit arrangement within the power driver 100. It is to be understood that other electrical arrangements may be provided as appropriate and as desired.

The LED modules 84 and heat dissipating plate 82 generally work together to evacuate heat away from the LEDs 90 quickly and easily. An LED fixture having some features as described herein is also described in Applicant's co-pending patent application entitled “LED Luminaire”, U.S. application Ser. No. 10/928,910, which was filed on Aug. 27, 2004, the entirety of which is hereby incorporated by reference.

In the illustrated embodiment, a “bell box” type of rear housing 104 is attached to the heat dissipating plate 82. Preferably the housing 104 encloses the driver 100, and is constructed of a heat conductive material such as aluminum. As such, the housing 104 accepts heat from the heat dissipating plate 82. Thus, the metal portions of the fixture 80 operate generally as a heat sink, allowing heat to be evacuated from the LEDs 90 and into the housing 104 for dispersal to the environment.

With continued reference to FIGS. 4 and 5, a cover plate 106 fits over the LED modules 84 and the heat dissipating plate 82. The cover plate 106 has an illumination aperture 108 that generally aligns with the LED modules 84 so that light from the modules passes through the illumination aperture 108. In one embodiment, the cover plate 106 is constructed of aluminum, and thus further aids in thermal management. Preferably, an optical element 110, such as a lens or diffuser, extends across the cover plate illumination aperture 108. In some embodiments, the optic 110 simply allows light to pass through substantially unaffected. In other embodiments, the optic 110 is adapted to narrowly focus or to broadly disperse the emitted light in any desired manner to best fit the particular application.

With continued reference to FIGS. 4 and 5, preferably the heat dissipating plate 82 is powder coated. Most preferably the power coat is white and has a generally rough surface texture. More specifically, preferably the powder coating process is performed such that the resulting surface is quite rough, bumpy, and the overall surface area of the mount member is increased significantly. Applicant has discovered that applying a bumpy-surfaced powder coat improves the heat conductivity properties of the heat sink/mount. Thus, not only does the mount member act as a heat sink, absorbing heat from the LED modules, but it also better disperses heat to the environment, even further improving its performance as a heat sink. In a preferred embodiment, the powder coat comprises TO13-WH09 polyester TGIC powder coating, such as is available from Cardinal Industrial Finishings.

Optical elements may be employed in conjunction with each light source 60 to direct the infrared light onto the screen 40 in a desired manner. For example, in one embodiment, narrowly focused optics directing light toward the screen 40 create one or more areas of concentrated light on the screen. In another embodiment, broadening optics spread the infrared light across the screen, achieving broad dispersion of infrared light. In still another embodiment, both broad and narrow optics can be used for different infrared sources and/or different portions of an infrared source. Other optics can also be used to achieve certain desired effects, such as lines across the screen, blotches, desired shapes, or the like.

In a still further embodiment, the optics and/or the mount of the LEDs may be movable, preferably by an electric motor, in order to move the infrared light about on the screen, thereby increasing its disruptive effect.

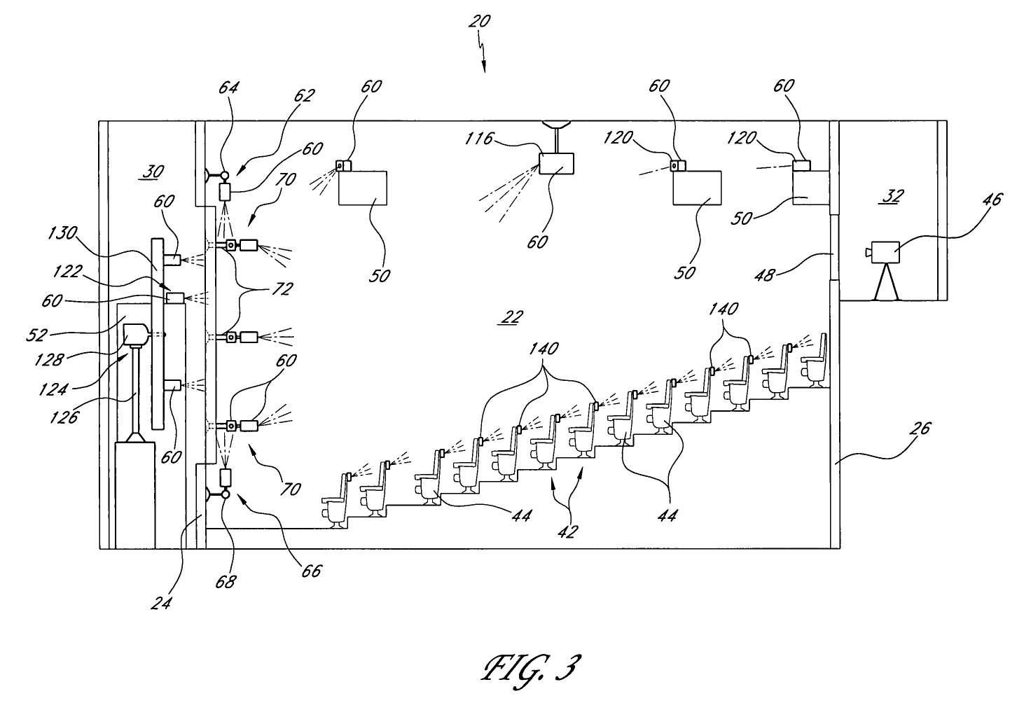

With reference again to FIGS. 1 and 3, in yet another embodiment, one or more infrared emitters 60 are mounted remotely from the screen, but are configured to direct infrared light at the screen. For example, infrared LED emitters 60 are mounted on wall-mounted speakers 50 and adapted to direct infrared light onto the screen 40. Additionally, in FIG. 3, a ceiling-mounted emitter 116 is illustrated, and is provided specifically for directing infrared light onto the screen 40.

In still further embodiments, one or more infrared LED-driven lasers 120 may be provided and adapted to direct infrared laser light onto the screen 40. In the illustrated embodiment, the infrared LED driven lasers 120 are mounted on speaker boxes 50. However, it is to be understood that they can be mounted in any desired manner in order to direct the laser light onto the screen, including being mounted in the projection room 32 behind the window 48. In one embodiment, a laser or group of lasers is attached to a movable motorized mount that moves the laser light about the screen 40 and can form words, shapes or the like. Additionally, laser splitters and other laser shaping technology can be used to form words, shapes or the like on the screen, preferably creating irritating and disruptive infrared images that move about the screen.

In accordance with additional embodiments, one or more infrared emitters 60 can direct infrared light toward the viewing area 22 in order to interfere with digital cameras being used by individuals in the audience. Additionally, infrared light can be directed throughout the theater 20, including the projection room 32, in order to fill the theater 20 with infrared light interference.

With reference again to FIGS. 1-3, infrared LED emitters 60 can be mounted immediately adjacent the screen 40 and are adapted to direct infrared light toward the audience in the viewing area 22. For example, in FIG. 2, the side mounts 72 disposed on either side of the screen 40, which in an embodiment discussed above include infrared emitters 60s adapted to direct light onto the screen, also include infrared emitters 60a adapted to direct light toward the audience.

Preferably, the light sources comprise one or more optical elements that broadly disperse the infrared light. Thus, a digital camera disposed in the viewing area will perceive a wash of infrared light that spreads from the point source across the screen and disrupts the screen image. In some embodiments, a digital camera will record the infrared light as a bright point-source combined with one or several lines that extend across the recorded image. Preferably, the light source 60a directs infrared light toward the viewing area 22 at very high intensity.

Although the illustrated embodiment presents several infrared emitters 60 mounted on the side mounts 72, it is to be understood that one, two or more such emitters may be provided adjacent the screen 40, and that emitters may be disposed above or below the screen as well. Further, in another embodiment, infrared emitters are attached to moveable, motorized mounts so that the emitted light will be in a constant state of motion in order to further disrupt the quality and watchability of the recorded digital image/movie. Further, in embodiments wherein a plurality of infrared emitters are employed, they may be adapted to work in concert to create areas, perhaps moving areas, of especially high-intensity infrared glare.

With particular reference to FIGS. 1 and 3, in another embodiment infrared emitters 60 are mounted in the stage area 30 behind the movie screen 40. The infrared emitters 60 preferably provide infrared light at sufficient intensity so that the light passes through the screen 40, thus disrupting a digitally-recordable image with an infrared light source directly within the visible screen image. Preferably, this embodiment is employed with a movie screen that is porous to light passing therethrough.

With continued reference to FIGS. 1 and 3, the stage-area infrared emitters can be mounted in various manners. For example, an emitter or group of emitters 122 is disposed upon a speaker box 52 or other type of mount behind the screen 40 so as to be disposed in an important area of the screen. In another embodiment, a rotating mount 124 is provided. Preferably the rotating mount 124 includes a podium 126 upon which an electric motor 128 is supported. A rotor arm 130 is preferably connected to the motor, and one or more infrared emitters 60 are provided on the rotor arm 130. The rotor arm 130 may move in a preprogrammed or randomized manner so as to create a constantly linearly moving, preferably inconsistently-moving, infrared light source that disrupts the digitally-recordable screen image.

In still another embodiment, an infrared light source such as a high intensity infrared LED communicates with a source of light dispersion/communication such as, for example, optical fibers. In one embodiment shown particularly in FIG. 2, several optical fibers 136 extend through the movie screen 40 at a plurality of locations. Since the optical fibers 136 are very small, they will not be detected by viewers watching the film, and will not disrupt the visible light image being projected onto the screen. However, several points of infrared light will be directed through the screen 40, disrupting any digital image that may be taken. In another embodiment, a plurality of infrared LED emitters are attached directly to the screen. Preferably, such emitters are attached to a back side of the screen and are adapted to direct light through the screen and toward the viewing area.

In yet another embodiment, infrared light sources 140 are mounted on the backs of seats 44 in the seating area 22 and direct infrared light onto each audience member, thus creating a flood of infrared light that disrupts digitally recorded images. It is to be understood that, in other embodiments, other locations of infrared light sources may be used. For example, infrared light sources may be mounted on the ceiling, floor, railings, walls, on the backs of speakers, or elsewhere. Optics may be chosen to narrow or broaden the dispersion of such infrared light in order to achieve desired disruptive effects.

It is not uncommon for a movie pirate to convince a projectionist to set up a camcorder or other digital imaging equipment in the projection room 32, and thus videotape the movie from the perspective of the projection room. In accordance with one embodiment, the projection room window 48 preferably includes a low pass filter coating, such as a layer of a dielectric interference filter, that is adapted to deflect infrared light but allow lower-wavelength visible light to pass through substantially unaffected. As such, the projected image is unaffected, but infrared light is reflected by the coated projection room window 48. In one embodiment, a source of infrared light is mounted on an edge of the glass pane that makes up the projection room window 48 so that infrared light is directed into the glass pane. The infrared deflecting coating deflects this infrared light, and thus the projection room window 48, being washed with infrared light, becomes a further hindrance and disruption to attempted digital videography, as the screen image will be diminished and/or completely washed out in the digitally-recorded image due to the deflected infrared light. It is to be understood that any type of infrared deflecting layer or method can be employed in accordance with other embodiments.

It is anticipated that movie pirates may attempt to counteract certain measures discussed herein by employing light filters in an attempt to diminish the infrared light detected by their digital imaging equipment. However, some infrared filters have a relatively narrow band, and thus may not filter out all wavelengths of infrared light, including deep red light. In another embodiment, two or more different types of infrared LED emitters are employed. A first type of LED emitter emits infrared light at a first wavelength, such as, for example, 850 nm. A second type of LED emitter emits infrared light at a second wavelength that is different than the first wavelength, such as, for example, 950 nm, or more than 1,000 nm. As such, a more complex filter arrangement must be anticipated and employed by a pirate to filter out any of the infrared light.

Infrared filters tend not to be able to filter out all of the infrared light. Preferably, the LED infrared emitters are adapted to emit infrared light at an intensity sufficient to at least partially overcome the filter so as to wash out and disrupt the digitally-recorded image even though the intensity is lessened somewhat by the filter.

The intensity of LED emitters can be further increased by “overdriving” such emitters. Overdriving refers to powering the emitters at an electrical current greater than their “rated” current as suggested by their manufacturer. The increased current causes the LED to shine brighter. However, the brighter LED also generates significantly more heat. Thus, in embodiments wherein LED emitters are overdriven so as to increase their brightness, such embodiments preferably use heat-sinking technology such as that exemplified in the LED fixtures 80 disclosed above in connection with FIGS. 4 and 5.

In additional embodiments, LEDs are overdriven only for short periods so as to avoid excessive heat buildup. Further, overdriven emitters may be supplied with active cooling systems, such as fans and radiated fluids. Additionally, depending on certain temperature and current conditions, when overdriving LEDs, the wavelength of the emitted light can be shifted about 10 nm upwardly or downwardly. Thus, overdriving the LEDs may further counter a pirate's attempt to filter infrared light by shifting the emitted light out of the band of light wavelengths filtered by a particular infrared filter.

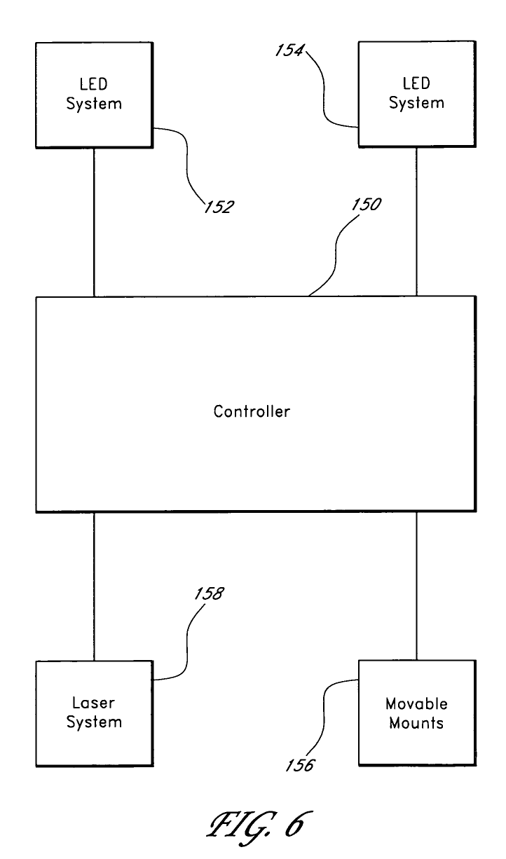

In additional embodiments, any one or all of the LEDs involved in disrupting digital imaging can be pulsed in order to further disrupt the imaging. Additionally, the brightness of LED emitters can be varied, both to further disrupt digital imaging and to control heat generation by the LED. With reference next to FIG. 6, a schematic control diagram is illustrated. In accordance with the illustrated embodiment, a centralized controller 150 regulates and directs operation of LED emitters. A first system 152, such as a plurality of LED emitters 60 disposed behind the screen 40, is controlled according to a first control sequence. Most preferably, the control sequence is a randomized sequence for pulsing the LEDs at frequencies ranging from about ½second to about two seconds or more between pulses. Of course, variations of pulse frequencies can be employed, including rapid-fire pulsing sequences that involve several pulses per second and pulses of varying light intensity. A randomized pulsing sequence avoids interference with infrared audio assist devices and does not create an impressionable pattern upon the human retina which could cause a muscle reaction leading to epileptic seizures. It has also been determined that a flashing disruption is much more irritating and disrupting to pirates than a consistent lightening or wash-out of the screen. Thus, pulsating operation of the infrared LEDs is preferred.

With continued reference to FIG. 6, a second system 154, such as LEDs adjacent the screen 40, is controlled according to a second control sequence that may be different than the first control sequence. This control sequence can be randomized or may be adapted to enable these LEDs to work in concert with one another or another system to create “hot spots” of especially concentrated infrared light directed onto the screen. A plurality of LED infrared sources may combine their output to create such hot spots.

The controller preferably also controls the operation of mechanically-movable mounts 156. In an embodiment wherein infrared LED emitters are mounted on movable, controllable mounts, the controller automatically controls not only the movement of each individual mount, but also the pulsation and brightness of each LED emitter, thus preferably precisely controlling creation of hot spots directed onto the screen, audience, or the like. Further, in the embodiment of the movable rotor arm disposed behind the screen, the rotation speed, direction, and such, in addition to the pulsation frequency, sequence randomization, light intensity, and the like, can be controlled as desired. In a still further embodiment, the controller can also control a laser-based system 158 that directs infrared laser light onto the screen to form predetermined shapes, patterns, and the like.

In the illustrated embodiment, a plurality of systems are controlled by the controller. However, a more simple arrangement in which a single system or even a single LED emitter is controlled according to desired sequences is contemplated. It is also anticipated that each LED emitter can be independently controlled as desired. Alternatively, in additional embodiments, groups of emitters can be simultaneously controlled, and, as discussed above, such groups can be adapted to work in concert to create certain lighting effects in order to more thoroughly disrupt a digitally recordable image.

In the illustrated embodiment, a single controller 150 is illustrated as controlling several systems. This principle can be expanded upon as appropriate. For example, a multi-theater cinema complex may employ a single controller to run all of the infrared anti-piracy systems in multiple theaters within the complex. Alternatively, several different controllers may be employed to control specific systems. Such controllers may work independently or, in another embodiment, be generally centrally controlled and regulated by a computer.

The embodiments discussed above have been directed to a movie theater application. It is to be understood that principles discussed herein can be used in a wide variety of applications. For example, theaters configured for live stage performances such as plays, concerts or the like, may employ aspects of some of the embodiments discussed herein to disrupt unauthorized digital photography of performances. In one embodiment, infrared light sources and/or reflectors are arranged on the set, scenery, costumes, or the like in order to disrupt digitally-recorded images.

Any venue or situation that may wish to disrupt unauthorized photography may use principles as discussed above. For example, art shows may employ such principles to disrupt unauthorized digital photography of displayed art. Further, the principles may be employed as intelligence countermeasures, or in situations where confidentiality is valued. Confidential meetings may employ such principles in order to interfere with spy photographs of confidential materials discussed or presented in the meeting. Display boards may include infrared LED emitters, and screens for presentations may be washed with infrared light.

In fact, any application in which a user wishes to resist digital photography can use principles discussed herein. For example, automobile companies typically create a test or “mule” car in order to test certain aspects of new models before such models are released to the public. Such companies often go to great lengths to disguise certain attributes of the car. In accordance with another embodiment, infrared LED emitters are arranged on the mule car to interfere with digital photographs of certain sensitive or confidential portions of the car so as to even better preserve the automaker's secret development. Research and development projects in other industries can also use this principle.

In still other embodiments, light sources that emit light in other wavelength ranges that are not visible to humans, such as the ultraviolet range, can be employed. It is anticipated that appropriate safety measures may be employed in such embodiments.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. For example, although FIGS. 1-3 show infrared light sources disposed at several locations in a cinema theater, other embodiments may employ only one or a few infrared sources, and may control such sources in accordance with any control strategy. Further, such an embodiment can also be used in a different application, such as an open-air live stage theater. Thus, it is intended that the scope of the present invention herein disclosed should not be limited by the particular disclosed embodiments described above, but should be determined only by a fair reading of the claims that follow.

What is claimed is:

1. A theater, comprising:
a stage area;
a viewing area comprising a plurality of seats arranged generally facing toward the stage area; and
a digital photography disruption system comprising an infrared light source adapted to direct infrared light generally outwardly from the stage area and at sufficient intensity to be detected by a semiconductor-based light sensor in the viewing area.

2. The theater of claim 1, wherein the infrared light source comprises a light emitting diode (LED).

3. The theater of claim 2 additionally comprising an optical component adapted to spread infrared light from the infrared light source over a broad viewing angle.

4. The theater of claim 2, wherein the stage area comprises a cinema screen.

5. The theater of claim 4, wherein the infrared light source is positioned adjacent the screen.

6. The theater of claim 4, wherein at least one LED is disposed on or in the screen.

7. The theater of claim 4, wherein at least one LED is disposed behind the screen.

8. The theater of claim 7, wherein the at least one LED is adapted to pulse according to a pulsing sequence.

9. The theater of claim 8, wherein the pulsing sequence comprises a random sequence of pulse frequencies.

10. The theater of claim 8, wherein the at least one LED is mounted on a movable mount.

11. The theater of claim 10, wherein the mount moves according to a movement sequence.

12. The theater of claim 11, wherein the pulsing sequence and movement sequence are electronically directed by a controller.

13. The theater of claim 8 additionally comprising a second infrared LED spaced apart from the at least one LED.

14. The theater of claim 4 additionally comprising an infrared LED adapted to direct infrared light onto the screen.

15. The theater of claim 2, wherein the at least one LED is positioned in the stage area.

16. The theater of claim 15, wherein the at least one LED is disposed on the stage set of a live theater production.

17. A screen viewing facility, comprising:
a stage area comprising a screen;
a viewing area generally adjacent the seating area and accommodating viewing of the screen; and
a digital photography disruption system comprising an infrared light source adapted to direct infrared light onto the screen at sufficient intensity to be detected by a semiconductor-based light sensor that is in the viewing area and is directed toward the screen.

18. The theater of claim 17, wherein infrared light is directed onto at least a portion of the screen at an intensity greater than an intensity of visible light projected onto the screen.

19. The theater of claim 17, wherein the infrared light source comprises an infrared laser.

20. The theater of claim 17, wherein the infrared light source comprises a plurality of infrared light-emitting diodes (LEDs) positioned to direct light at the screen.

21. The theater of claim 20, wherein the infrared light source is attached to a heat sink.

22. The theater of claim 20, comprising first and second infrared light sources that are spaced apart from one another, the first and second light sources comprising LEDs that are positioned to direct light at the screen, the first and second sources adapted to simultaneously direct light at a target portion of the screen.

23. A method of disrupting digital photography of a subject, comprising:
providing a source of electromagnetic radiation substantially outside of the visible electromagnetic spectrum;
positioning the radiation source on or adjacent the subject; and
directing the invisible electromagnetic radiation from the source toward a viewer of the subject;
wherein the electromagnetic radiation is provided at an intensity sufficient to be detected by a semiconductor light sensor, but is substantially invisible to a viewer of the subject.

24. The method of claim 23 additionally comprising providing an optical member adapted to direct the light from the source across a broad viewing angle.

25. The method of claim 23, wherein the source emits radiation according to a random pulse frequency sequence.

26. The method of claim 25, wherein the source emits infrared radiation.

27. The method of claim 26, wherein the source comprises a light emitting diode (LED).
